(19) United States
(12) Patent Application Publication
(10) Pub. No.: US 2009/0054056 A1
(43) Pub. Date: Feb. 26, 2009

(54) SERVICE CHARACTERISTIC EVALUATION IN A CELLULAR COMMUNICATION SYSTEM

(75) Inventor: Jose L. Gil, Barcelona (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/278,402

(22) PCT Filed: Feb. 9, 2007
(86) PCT No.: PCT/US07/61900

§ 371 Date: Aug. 6, 2008

(30) Foreign Application Priority Data
Mar. 6, 2006 (GB) 0604391.3

(51) Int. Cl. H04W 24/00

(52) U.S. Cl. 455/423

(57) ABSTRACT

A cellular communication system (100) comprises a service evaluation server (117) for performing service characteristic evaluation. The server (117) comprises a profile store (201) which stores different service characteristic profiles for a plurality of remote stations. Each service characteristic may correspond to a service level agreement. A measurement operation processor (203) determines a set of measurement operations for a first remote station (101) in response to a first service characteristic profile for the first remote station (101). A measurement command processor (205) then determines a set of measurement commands corresponding to the measurement operations and a network transmit processor (207) transmits the set of measurement commands to the first remote station (101). The first remote station (101) decodes the commands, performs the measurement operations and transmits the resulting measurement data to the server (117). A network receive processor (211) receives the measurement data and a service characteristic processor (213) determines an experienced service characteristic profile for the first remote station (101) in response to the measurement data.

### FIELD OF THE INVENTION

The invention relates to service characteristic evaluation in a cellular communication system and in particular but not exclusively to evaluation of service characteristics specified in service level agreements.

### BACKGROUND OF THE INVENTION

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems have recently been rolled out in many areas to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876. The core network of UMTS is built on the use of SGSNs and GGSNs thereby providing commonality with GPRS.

Service Level Agreements (SLAs) are fundamental in the commercial running of cellular communication systems. Service Level Agreements formalise a contractual agreement between the user of a service/network and the operator of the service/network.

Users pay for a service according to the SLA and the network or service provider must deliver the services, performance and quality of service defined in the SLA agreement. The measurement and monitoring of SLAs is of crucial importance for both service users and providers to verify that the requirements of the SLA are being met.

However, in conventional telecommunication systems it is difficult to monitor the operation to determine if the SLA requirements are met and this leads to a number of disadvantages, including the following:

1. SLAs are mostly restricted to those metrics that are simple to measure in order to ensure that conformity with the SLA can be verified. However these metrics typically do not correspond to the metrics which are of most interest and of highest importance to the network users, service providers and network operator. This disadvantage arises from the difficulty in measuring many of the metrics of interest. For example, end-to-end metrics which are required to be measured or monitored at the end host can generally not be provided.

2. Traditionally it is the network operator that measures the SLA at a specific network point (a point they own). However, subscribers or independent organizations such as telecom regulators have found it difficult to measure and monitor compliance with SLAs due to an inability to access the network. Furthermore, telecom operators do not always own the end device and therefore cannot measure any end-point metric.

3. Conventional approaches do not allow measurement of end-to-end SLAs in mobile subscriber's devices. Currently there is no method or solution to measure SLAs at the mobile point because there is no access to such units.

Thus, conventional approaches do not allow characteristics of the provided services to be evaluated sufficiently well to allow an efficient and optimum verification that the requirements of an SLA are met. Hence, an improved system for service characteristic evaluation would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system comprising an apparatus for service characteristic evaluation; the apparatus comprising: storage means for storing different service characteristic profiles for a plurality of remote stations; means for determining a set of measurement operations for a first remote station in response to a first service characteristic profile for the first remote station; means for determining a set of measurement commands corresponding to the measurement operations; means for transmitting the set of measurement commands to the first remote station; means for receiving measurement data corresponding to the set of measurement operations from the first remote station; and means for determining an experienced service characteristic profile for the first remote station in response to the measurement data.

The invention may allow an improved service characteristic evaluation.

The invention may allow a flexible determination of service characteristics to be evaluated and may allow remote stations to be controlled to provide measurements adapted for the required (e.g. end-point) service characteristics. The apparatus may be operated independently of the network operator and may for example be operated by a regulation body. The invention may allow more accurate and/or advanced service characteristics to be determined. The determined service characteristics may provide an improved indication of the user experienced service level (such as end-to-end characteristics).

The invention may allow an improved determination and evaluation of service characteristics. In particular, the invention may allow an improved verification that experienced service characteristics meet service requirements specified in an SLA. For example, the invention may allow different end-point service characteristics to be verified for different SLAS.

According to an optional feature of the invention, the first remote station comprises: means for receiving the set of measurement commands; means for determining the set of measurement operations in response to the measurement commands; means for performing the measurement operations to determine the measurement data; and means for transmitting the measurement data to the apparatus.

The invention may allow an improved service characteristic evaluation by allowing the apparatus to control measurement operations at the remote station which are required or desired for evaluating the specific service characteristics.

According to an optional feature of the invention, measurement operations are different for at least two of the different service characteristic profiles and the apparatus is arranged to send a different set of measurement commands for a different set of measurement operations to a second remote station.

The invention may allow a variety of different complex characteristics to be evaluated for different remote stations. The remote station measurements required to provide desired characteristics for evaluating the service, such as end-to-end performance characteristics, can be specifically adapted to the requirements for the service characteristic profile of that remote station. The invention may facilitate differentiated service characteristic evaluation for different remote stations. For example, different remote stations may be associated with different SLAs and may accordingly have different associated service characteristic profiles resulting in different remote station measurement operations being performed and different service characteristics being evaluated.

According to an optional feature of the invention, the set of measurement commands comprises programme code for a measurement application.

The programme code may for example be an executable code or a code for compilation at the remote station. The feature may allow increased flexibility and/or improved measurement operations thereby allowing an improved service characteristic evaluation.

According to an optional feature of the invention, the first remote station is arranged to operate on a plurality of different radio access networks.

The different radio access networks may be radio access networks using different air interface technologies or may operate in accordance with different air interface standards. The invention may provide improved service characteristic evaluation for multi-radio access network capable remote stations. The invention may in particular allow a flexible and accurate service characteristic evaluation taken into account the different radio access networks.

According to an optional feature of the invention, the set of measurement operations comprise a measurement of a performance parameter and the measurement data comprises a combined measurement parameter of the performance parameter for a plurality of different radio access networks.

This may provide an improved service characteristic evaluation which e.g. may reflect the actual averaged service level experienced by the user. The combined measurement parameter may for example be a throughput measure which is averaged across the different radio access networks.

According to an optional feature of the invention, the set of measurement operations comprise different measurement operations for different radio access networks.

This may provide an improved service characteristic evaluation which e.g. reflects the service level provided by the individual radio access network. The combined measurement parameter may for example be a throughput measure for each individual radio access network.

According to an optional feature of the invention, the experienced service characteristic profile comprises a combined parameter for a plurality of the radio access networks.

This may provide an improved service characteristic evaluation.

According to an optional feature of the invention, the experienced service characteristic profile comprises at least one parameter reflecting a service parameter of only one of the radio access networks.

This may provide an improved service characteristic evaluation.

According to an optional feature of the invention, the measurement data comprises measurement data for at least one service characteristic selected from the group consisting of: a coverage characteristic for the first remote station;

a throughput characteristic for the first remote station;

a call setup failure characteristic for the first remote station; a packet setup failure characteristic for the first remote station; a Packet Data Protocol context activation failure characteristic for the first remote station; and an attach success characteristic for the first remote station.

The invention may specifically allow a service characteristic evaluation based on parameters that are particularly advantageous for evaluating the perceived user service level.

According to an optional feature of the invention, the cellular communication system further comprises means for detecting a discrepancy in response to a comparison between the first service characteristic profile and the experienced service characteristic profile.

This may allow an improved service characteristic evaluation where a failure to meet defined service characteristics can be detected. For example, the invention may allow a detection of a failure to meet the requirements of an SLA. The discrepancy may for example be determined in response to a statistical evaluation and/or it may be detected if a certain criterion for the comparison is met. E.g. it may be detected that a certain number of measured characteristics have not met the requirements within a given time interval. The apparatus may for example comprise functionality for generating a user notification in response to the detection of the discrepancy.

According to an optional feature of the invention, the experienced service characteristic profile is associated with a group of remote stations.

This may facilitate service characteristic evaluation in many embodiments and may for example facilitate verification that the requirements of an SLA for a group of remote station are met.

According to an optional feature of the invention, the apparatus is arranged to transmit the measurement commands in accordance with an Open Mobile Alliance standard.

This may allow improved performance and/or facilitate implementation. In particular, it may provide compatibility with other functionalities of a cellular communication system and may facilitate implementation using standard hardware and software.

According to an optional feature of the invention, the measurement command comprises a SyncML application.

This may allow improved performance and/or facilitate implementation. In particular, it may provide compatibility with other functionalities of a cellular communication system and may facilitate implementation using standard hardware and software.

According to another aspect of the invention, there is provided an apparatus for service characteristic evaluation; the apparatus comprising: storage means for storing different service characteristic profiles for a plurality of remote stations; means for determining a set of measurement operations for a first remote station in response to a first service characteristic profile for the first remote station; means for determining a set of measurement commands corresponding to the measurement operations; means for transmitting the set of measurement commands to the first remote station; means for receiving measurement data corresponding to the set of measurement operations from the first remote station; and means for determining an experienced service characteristic profile for the first remote station in response to the measurement data.

According to another aspect of the invention, there is provided a method of service characteristic evaluation for a cellular communication system; the method comprising: storing different service characteristic profiles for a plurality of remote stations; determining a set of measurement operations for a first remote station in response to a first service characteristic profile for the first remote station; determining a set of measurement commands corresponding to the measurement operations; transmitting the set of measurement commands to the first remote station; receiving measurement data corresponding to the set of measurement operations from the first remote station; and determining an experienced service characteristic profile for the first remote station in response to the measurement data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a service evaluation server in accordance with some embodiments of the invention; and

FIG. 3 illustrates an example of a remote station in accordance with some embodiments of the invention.

### DETAILED DESCRIPTION OF SOME EMBODIMENTS OF THE INVENTION

The following description focuses on embodiments of the invention applicable to a UMTS cellular communication system. However, it will be appreciated that the invention is not limited to this application but may be applied to many other cellular communication systems including for example GSM cellular communication systems or hybrid cellular communication systems comprising different radio access networks.

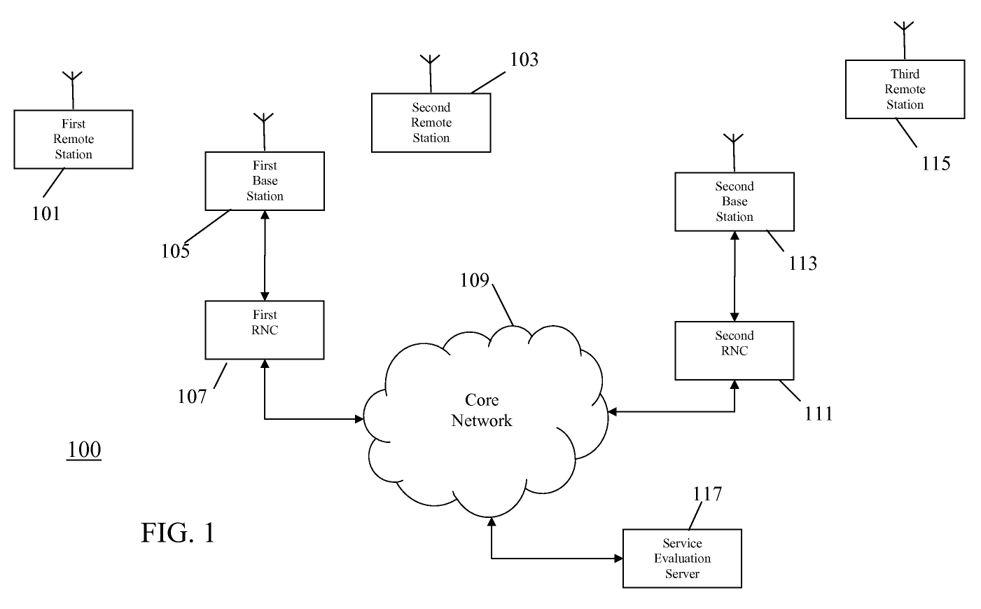

FIG. 1 illustrates an example of a cellular communication system 100 in which embodiments of the invention may be employed.

In a cellular communication system, a geographical region is divided into a number of cells each of which is served by a base station. The base stations are interconnected by a fixed network which can communicate data between the base stations. A remote station (e.g. a User Equipment (UE) or a mobile station) is served via a radio communication link by the base station of the cell within which the remote station is situated.

As a remote station moves, it may move from the coverage of one base station to the coverage of another, i.e. from one cell to another. As the remote station moves towards a base station, it enters a region of overlapping coverage of two base stations and within this overlap region it changes to be supported by the new base station. As the remote station moves further into the new cell, it continues to be supported by the new base station. This is known as a handover or handoff of a remote station between cells.

A typical cellular communication system extends coverage over typically an entire country and comprises hundreds or even thousands of cells supporting thousands or even millions of remote stations. Communication from a remote station to a base station is known as uplink, and communication from a base station to a remote station is known as downlink.

In the example of FIG. 1, a first remote station 101 and a second remote station 103 are in a first cell supported by a first base station 105.

The first base station 105 is coupled to a first RNC 107. An RNC performs many of the control functions related to the air interface including radio resource management and routing of data to and from appropriate base stations.

The first RNC 107 is coupled to a core network 109. A core network interconnects RNCs and is operable to route data between any two RNCs, thereby enabling a remote station in a cell to communicate with a remote station in any other cell. In addition, a core network comprises gateway functions for interconnecting to external networks such as the Public Switched Telephone Network (PSTN), thereby allowing remote stations to communicate with landline telephones and other communication terminals connected by a landline. Furthermore, the core network comprises much of the functionality required for managing a conventional cellular communication network including functionality for routing data, admission control, resource allocation, subscriber billing, remote station authentication etc.

The core network 109 is further coupled to a second RNC 111 which is coupled to a second base station 113. The second base station 113 supports a third remote station 115.

In the example, the system 100 furthermore comprises a service evaluation server 117 which is arranged to evaluate the service characteristics for services provided to the different remote stations. Specifically, the service evaluation server 117 can evaluate service characteristics that correspond to the characteristics specified in an SLA.

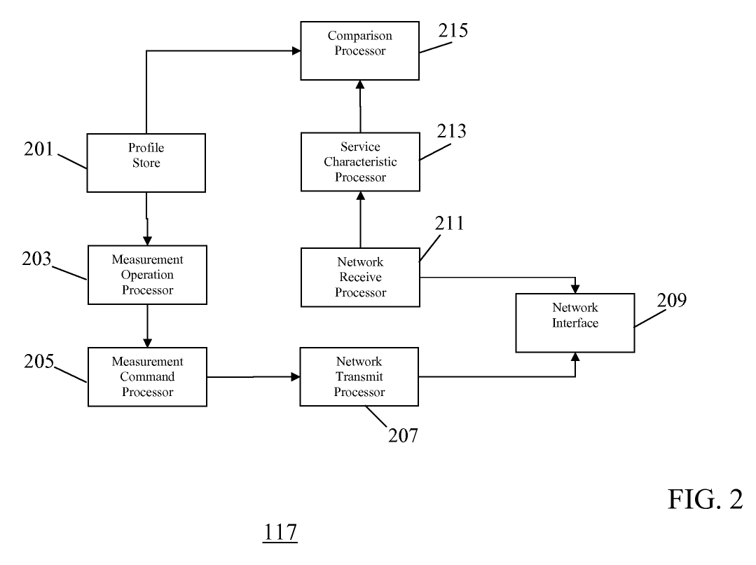

FIG. 2 illustrates an example of the service evaluation server 117 in more detail.

The service evaluation server 117 comprises a profile store 201 which stores different service characteristic profiles for a plurality of remote stations. Specifically, different SLAs may be defined for different remote stations (or typically groups of remote stations) with each SLA defining a number of service characteristics and the performance requirements for these characteristics. For each of the defined SLAs, a service profile is generated and stored in the profile store 201. In the example, a service profile defines one or more service characteristics together with the performance values that must be met. Each service profile can correspond directly to the requirements of an SLA Furthermore, as an individual SLA may relate to a single remote station, but typically relates to a group of remote stations, such as those supporting subscribers of a virtual operator having agreed the SLA with the network operator, each service profile may be associated with one or more remote stations.

As an example, the cellular communication system 100 can provides services to a plurality of virtual operators, each of which supports a group of remote stations. Each of the virtual operators has agreed an SLA with the operator of the communication system, and for each virtual operator a corresponding service profile is stored in the profile store 201.

The profile store 201 is coupled to a measurement operation processor which is arranged to determine a set of measurement operations for one or more remote stations in response to a first service characteristic profile for the remote stations. For example, the measurement operation processor 203 can extract the service profile for a first virtual operator and may proceed to determine which service characteristics are defined in the service profile. The measurement operation processor 203 then proceeds to determine which measurements must be performed by the remote stations in order to allow the actual experienced values for the defined service characteristics to be determined.

For example, the profile stored for a first virtual operator can include a requirement that the system provides coverage for the remote stations of the first virtual operator for 99% of the time. Accordingly, the measurement operation processor 203 determines that a coverage measurement operation should be performed by the remote stations of the first virtual operator. For example, these remote stations may measure the proportion of time in which a sufficiently strong pilot signal can be detected from the base stations of the communication system.

The measurement operation processor 203 is coupled to a measurement command processor 205 which is arranged to determine a set of measurement commands corresponding to the measurement operations.

For example, a number of measurement operations can be predefined for different service characteristics and each remote station can be designed and manufactured with functionality for performing these measurement operations. In addition, a command language for instructing the remote stations which specific measurements to perform can be defined. In such an example, the measurement command processor 205 can receive information from the measurement operation processor 203 that specifies which measurements operations are to be performed by the remote stations. In response, the measurement command processor 205 determines the commands that must be sent to the remote station in order for these to select and initialise the desired operations.

As a specific example, the measurement command processor 205 can receive a measurement operation identifier from the measurement operation processor 203 and can in response access a look-up table that provides the predefined measurement command(s) for this operation.

In some embodiment, the measurement command processor 205 may generate commands in the form of programme code for a measurement application that can be executed by the remote station. For example, in response to receiving a measurement operation identifier from the measurement operation processor 203, the measurement command processor 205 may retrieve an executable file which went executed by a remote station results in the appropriate measurement operation being performed.

As a specific example, the remote station can be arranged to execute downloaded applications. The measurement command processor 205 can access a store comprising an executable file which corresponds to a measurement operation that determines a proportion of time in which a remote station is within the coverage of the cellular communication system. If the measurement operation processor 203 determines that the service profile for a given remote station comprises a requirement that the remote station must be within coverage for a given proportion of the time, it will identify the coverage measurement operation and the measurement command processor 205 will retrieve the executable file and cause it to be downloaded to the remote station for execution.

Specifically, the Open Mobile Alliance (OMA) has standardised a protocol and procedure for downloading and executing applications in a remote station. One such example is the SyncML application procedure which allows the remote station to perform a series of customised activities. Thus, the measurement command processor 205 and the service evaluation server 117 may specifically use the OMA standard and especially the SyncML application to control a remote station to provide the desired data.

The measurement command processor 205 is coupled to a network transmit processor 207 which is arranged to transmit the measurement commands to the appropriate remote stations. Specifically the network transmit processor 207 is coupled to a network interface 209 which provides an interface between the service evaluation server 107 and the core network 109.

Thus, the service evaluation server 117 can identify the measurement operations which are required to determine if a remote station, e.g. the first remote station 101 of FIG. 1, meets the service characteristic requirements defined in a service characteristic profile, for example based on an SLA. It furthermore comprises functionality for controlling a remote station to perform these measurements.

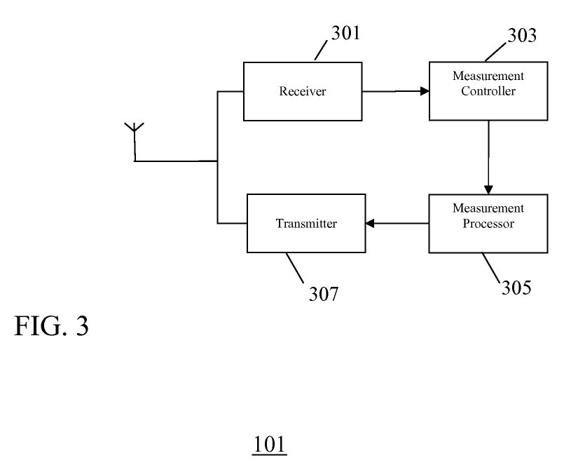

FIG. 3 illustrates an example of a remote station in accordance with some embodiments of the invention. The remote station may for example be the first remote station 101 of FIG. 1.

The remote station 101 comprises a receiver 301 which is operable to receive messages transmitted over the air interface of the cellular communication system. Specifically, the receiver 301 can receive a message from the service evaluation server 117 comprising the measurement commands. The receiver 301 is coupled to a measurement controller 303 which is arranged to determine the set of measurement operations indicated by the measurement commands. The measurement controller 303 is coupled to a measurement processor 305 which performs the measurement operations determined by the measurement controller 303. The measurement processor 305 is furthermore coupled to a transmitter 307 which is arranged to transmit messages over the air interface of the cellular communication system. Specifically the measurement processor 305 generates measurement reporting messages that report the results of the performed measurement operations. These reporting messages are then transmitted to the service evaluation server 117 by the transmitter 307 and via the first base station 105, the first RNC 107 and the core network 109.

Thus, the first remote station 101 comprises functionality for receiving the measurement commands from the service evaluation server 117 and for performing the specified measurements. Accordingly, the service evaluation server 117 can control the measurements performed by the first remote station 101 and thus can determine which measurement data is generated and provided to the service evaluation server 117 from the remote stations.

As an example, the service evaluation server 117 may generate commands that correspond to identifiers for measurement operations for which the required functionality is already present in the first remote station 101 (e.g. the first remote station may be designed to be able to perform a range of measurements). When the measurement controller 303 receives a measurement command it proceeds to select and initiates the corresponding predefined measurement operation resulting in the required measurement data being generated and transmitted to the service evaluation server 117.

In other embodiments, the service evaluation server 117 may additionally or alternatively download some programme code which is forwarded by the measurement controller 303 to the measurement processor 305 which proceeds to execute the program. Whereas the first approach may provide facilitated operation and a lower communication resource requirement, the second approach may provide substantially more flexibility and in particular does not require that the first remote station 101 is designed and manufactured to perform the specific measurement operations.

The network interface 209 of the service evaluation server 117 is furthermore coupled to a network receive processor 211 which is arranged to receive the measurement data that is generated by the measurement operations performed by the measurement processor 305.

The network receive processor 211 is coupled to a service characteristic processor 213 which is arranged to determine an experienced service characteristic profile for the first remote station 101 in response to the measurement data. The experienced service characteristic profile may correspond to the stored service characteristic profile for the remote station but with the actual measured service characteristics values for each service characteristic.

Thus, the service evaluation server 117 can retrieve a service profile corresponding to an SLA and can control a remote station to perform required measurement operations to generate the required measurement data. This allows the service evaluation server 117 to determine which service characteristic is actually experienced at the remote station. Thus, a centralised network based server can provide differentiated service level information which accurately reflects the specific service profile requirements for that remote station as well as the actual service levels experienced by the user of the remote station. This is in contrast to conventional system where network based evaluation of service levels is based on standardised remote station measurements and network information thereby restricting the service characteristics that can be determined (and the accuracy thereof). Thus, the service evaluation server 117 allows the determination of service characteristics which accurately reflect the actual service level experience by the user, such as an end-to-end performance.

A specific example of a service characteristic that may be evaluated by the service evaluation server 117 is an outage characteristic. For example, corporations are important customers for mobile operators. Corporations are interested in having coverage all the time and anywhere. The described approach allows an SLA for a corporation to state, for example, that a remote station should be in good radio coverage for X percent of the time it is switched on (e.g. 99%). Applying the described approach, this SLA can be input to the service evaluation server 117 in the form of a service characteristic profile. The service evaluation server 117 can then automatically determine which measurement operations and measurement data is required from the remote stations covered by the SLA. The service evaluation server 117 specifically requests the pertinent remote station to measure the time they are out of coverage (users and operator can e.g. define a minimum beacon receive signal strength level that corresponds to the remote station being in coverage. This level can be included in the service characteristic profile). Remote stations can receive the appropriate instructions through a SyncML application. At specified time intervals configured at the service evaluation servers 117, the remote stations can report the time they have been out of coverage.

Thus, in contrast to conventional systems wherein the proportion of time a remote station is in coverage cannot be determined (it cannot be determined from standard measurements or measurements by the fixed network), the current approach allows the evaluation of a coverage characteristic and thus allows SLAs to define a requirement for a characteristic of significant importance to a user.

It will be appreciated that many other service characteristics may be measured and evaluated in accordance with different embodiments of the invention. Furthermore, the service characteristic profiles may typically define a plurality of service characteristics that should be evaluated.

For example, the service evaluation server 117 may arrange for a throughput characteristic to be determined for the remote station. This throughput characteristic may for example be a throughput data rate which is the actual data rate experience by the user and thus can represent an end-to-end throughput data rate.

As another example, the service evaluation server 117 may arrange for an evaluation of a measure of the success/failure of the remote station in setting up new communications.

For example, the service evaluation server 117 may instruct the remote station to count all the times it has been successful or unsuccessful in setting up a new communication, such as a new call or packet data session. Thus, the first remote station may count the number of times a Packet Data Protocol context activation or a circuit switch call request has been successful/unsuccessful. It may then provide measurement data to the service evaluation server 117 which indicates the proportion of successful (or failed) call setups or attach procedures. As another example, the service evaluation server can be provided with the information of how successful the first remote station is in a attaching to be network. The approach allows a significantly more accurate determination than a network based approach as the remote station can also count the number of attempts which were not received or detected by the network. Other examples include:
jitter (important metric for many real-time applications).
loss of packets at the remote station.
round trip time between a remote station and an external device coupled to the remote station such as a laptop (e.g. when a laptop is connected to a remote station for Internet access—web browsing, e-mail, etc)
handover failure rate.

Thus, the described approach allows the service evaluation server 117 to determine an availability characteristic for the cellular communication system and thereby allows e.g. SLAs to define availability requirements.

Furthermore, the approach allows the operation of the individual remote station to automatically be adapted to the specific service requirements for that remote station. Thus, different remote stations served by the communication system can have different characteristics defined in their service characteristic profile thereby allowing a further flexibility in the generation of SLAs and the verification that the individual remote station or group of remote stations meet the defined requirements.

In the specific example, the service evaluation server 117 furthermore comprises a comparison processor 215 which is coupled to the profile store 201 and the service characteristic processor 213. The comparison processor 215 is arranged to detect a discrepancy between the requirements defined in the service characteristic profile stored in the profile store 201 and the actual values determined for the service characteristic by the remote station.

In a simple embodiment, the comparison processor 215 can simply compare each individual measured service characteristic to the stored requirement. If a discrepancy is found, the comparison processor 215 can generate an alarm or user notification. Specifically the comparison processor 215 can generate a log file that records all detected discrepancies. This file can then be evaluated e.g. by the virtual operator or the network operator to determine if the SLA is met.

In other more complex embodiments, the comparison processor 215 may perform a statistical evaluation of the measurement data and the stored requirements and/or may combine the data for a plurality of remote stations.

In some embodiments, the cellular communication system may comprise a plurality of different Radio Access Networks (RAN). Each RAN uses a different interface technology and can operate in accordance with different technical standards. For example the cellular communication system may comprise a GSM RAN and a UMTS RAN coupled to the core network 109. Also, one or more of the remote stations may be multimode remote stations which can operate on different RANs and may specifically be combined GSM/UMTS remote stations.

In such embodiments, the service evaluation server 117 can be arranged to take the existence of different RANs into account.

For example, an SLA may be defined for a remote station with a number of requirements for specific service characteristics which are to be met regardless of which RAN is supporting the remote station.

As a specific example, an SLA may be agreed which requires that an average throughput rate must be at least a given minimum rate. For example, an Internet browsing service may be specified to provide an average rate of at least 64 kbps. Thus the minimum average data rate may be specified but with no consideration of whether this is provided through a GSM RAN, a UMTS RAN or a combination of both. Thus, a service characteristic profile having a combined service characteristic requirement may be stored in the service evaluation server 117. Accordingly, the service evaluation server 117 may instruct the remote station to measure the average data rate provided to the end point service (the Internet browsing service). Accordingly, the remote station can at specified intervals report the average data rate. However, the downloaded data may have been received via GSM, UMTS or both. Thus, the system may allow an SLA to be defined which does not need to consider the specific characteristics of the individual air interface technology but rather may be defined directly in terms of the service levels experienced by the end user.

Alternatively or additionally, an SLA for a group of multimode remote stations can comprise requirements which are related to the specific RAN. For example, a minimum average data rate may be required when the remote station is supported by a GSM RAN and a different minimum average data rate may be required when the remote station is supported by a UMTS RAN. In such cases, the service characteristic profile may comprise different service characteristic requirement for the different RANs and the service evaluation server 117 may determine a different measurement operation to be performed depending on the which RAN is supporting the remote station.

As another example, a specific service characteristic may only be relevant to a subset of the RANs. For example, a service characteristic may relate to a service that can only be supported on one of the RANs. For example, a high-quality video service may require a high data rate and may therefore be supported by UMTS RAN but not a GSM RAN. For such a service, a frame rate requirement may e.g. be specified for the UMTS RAN but not the GSM RAN.

In some embodiments, different service characteristics and measurement operations may be defined for different RANs supporting the same service. For example, a service characteristic related to handovers may be defined differently and can be based on different measurement operations for a UMTS RAN (that supports soft handovers) and GSM RAN (that does not support soft handovers).

As a specific example, the above described approaches may be used to verify compliance with seamless mobility SLAs. Specifically, with the introduction of remote stations supporting seamless mobility, subscribers will be able to stay connected and access content information at any time and any place. For such applications, the described approach allows a flexible definition and compliance testing for SLAs. As an example one SLA metric could be related to obtain an end-to-end application throughput (say a WAP application) of X Kbps on average. Once the SLA metric is included in a service characteristic profile, the appropriate commands can be sent to the pertinent remote stations to instruct them to measure the application throughput. The remote station can specifically perform throughput measurements as instructed by a SyncML application. The throughput measurements are then transferred from the remote stations to the service evaluation server 117, which determines the average throughput per remote station and compares it against the SLA throughput thresholds agreed by users and mobile operator. Due to the seamless mobility, the remote station may be moving across different technologies or RANs during a data transfer. For a mobile operator that might own several different access technologies it is typically very complex to determine the actual end-to-end throughput from just network statistics (it would require a correlation of statistics from different networks/RANs). However with the described approach it is a very simple task to measure the end-to-end throughput at the remote station side, and then to report it back to the central service evaluation server.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising an apparatus for service characteristic evaluation; the apparatus comprising:
storage means for storing different service characteristic profiles for a plurality of remote stations;
means for determining a set of measurement operations for a plurality of different radio access networks that can be operated on by a first remote station in response to a first service characteristic profile for the first remote station, wherein the set of measurement operations comprise a measurement of a performance parameter for each of the plurality of different radio access networks;
means for determining a set of measurement commands corresponding to the measurement operations;
means for transmitting the set of measurement commands to the first remote station;
means for receiving measurement data corresponding to the set of measurement operations from the first remote station, wherein the measurement data comprises a combined measurement parameter of the performance parameters for the plurality of different radio access networks; and
means for determining an experienced service characteristic profile for the first remote station in response to the measurement data.

2. The cellular communication system of claim 1 wherein the first remote station comprises:
means for receiving the set of measurement commands;
means for determining the set of measurement operations in response to the measurement commands;
means for performing the measurement operations to determine the measurement data; and
means for transmitting the measurement data to the apparatus.

3. The cellular communication system of claim 1 wherein measurement operations are different for at least two of the different service characteristic profiles and the apparatus is arranged to send a different set of measurement commands for a different set of measurement operations to a second remote station.

4. The cellular communication system of claim 1 wherein the set of measurement operations comprise different measurement operations for different radio access networks.

5. The cellular communication system of claim 1 wherein the experienced service characteristic profile comprises a combined parameter for a plurality of the radio access networks.

6. The cellular communication system of claim 1 wherein the experienced service characteristic profile comprises at least one parameter reflecting a service parameter of only one of the radio access networks.

7. The cellular communication system of claim 1 wherein the measurement data comprises measurement data for at least one service characteristic selected from the group consisting of:
a coverage characteristic for the first remote station;
a throughput characteristic for the first remote station;
a call setup failure characteristic for the first remote station;
a packet setup failure characteristic for the first remote station;
a Packet Data Protocol context activation failure characteristic for the first remote station; and
an attach success characteristic for the first remote station.

8. The cellular communication system of claim 1 further comprising means for detecting a discrepancy in response to a comparison between the first service characteristic profile and the experienced service characteristic profile.

9. The cellular communication system of claim 1 wherein the experienced service characteristic profile is associated with a group of remote stations.

10. A method of service characteristic evaluation for a cellular communication system; the method comprising:
storing different service characteristic profiles for a plurality of remote stations;
determining a set of measurement operations for a plurality of different radio access networks that can be operated on by a first remote station in response to a first service characteristic profile for the first remote station, wherein the set of measurement operations comprise a measurement of a performance parameter for each of the plurality of different radio access networks;
determining a set of measurement commands corresponding to the measurement operations;
transmitting the set of measurement commands to the first remote station;
receiving measurement data corresponding to the set of measurement operations from the first remote station, wherein the measurement data comprises a combined measurement parameter of the performance parameters for the plurality of different radio access networks; and
determining an experienced service characteristic profile for the first remote station in response to the measurement data.
